(19) United States
(12) Patent Application Publication
(10) Pub. No.: US 2007/0269650 A1
(43) Pub. Date: Nov. 22, 2007

(54) Coating Materials

(75) Inventors: Jorg Leuninger, Mainz (DE); Franca Tiarks, Ludwigshafen (DE); Harm Wiese, Heidelberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/718,729

(22) PCT Filed: Oct. 27, 2005
(86) PCT No.: PCT/EP05/11486

§ 371 Date: May 7, 2007

(30) Foreign Application Priority Data
Nov. 5, 2004 (DE) 10 2004 054 048.9

(51) Int. Cl. B32B 5/16; B05D 3/02; C09D 1/00

(52) U.S. Cl. 428/327; 106/286.2; 427/372.2

(57) ABSTRACT

Aqueous coating materials comprising a) particles having an average size ≧10 nm and ≦500 nm composed of addition polymer and finely divided inorganic solid (composite particles) and b) at least one pulverulent pigment selected from the group comprising zinc oxide, zinc sulfide, iron(III) oxide, tin dioxide and also titanium dioxide in the rutile, anatase and brookite modification.

The present invention relates to an aqueous coating material comprising
a) particles having an average size ≧10 nm and ≦500 nm composed of addition polymer and finely divided inorganic solid (composite particles) and
b) at least one pulverulent pigment selected from the group comprising zinc oxide, zinc sulfide, iron(III) oxide, tin dioxide and also titanium dioxide in the rutile, anatase and brookite modification.

To give paints good hiding power and the desired color, pigments are used. On the basis of its high refractive index, titanium dioxide is the most important white pigment. Among the variously occurring modifications of titanium dioxide, namely rutile, anatase and brookite, rutile, at 2.7, has the highest refractive index, and so, for the preparation of coating materials, titanium dioxide in the rutile modification, in particular, is used.

Recent years, however, have seen increased use of titanium dioxide in the anatase modification (anatase for short) in coating materials, on account of the fact that these coating materials, owing to their very hydrophilic and also strongly oxidative surfaces, have a high soiling resistance. Responsibility for these extremely hydrophilic surfaces is attributed to photocatalytic effects of the anatase, which under the action of UV light, atmospheric oxygen and water form free radicals. Similar, albeit attenuated, photocatalytic effects are also reported, for example, for the pigments zinc oxide (ZnO), zinc sulfide (ZnS), iron(III) oxide (Fe₂O₃) and tin dioxide (SnO₂). In a markedly attenuated form, photocatalytic effects of this kind are also known for titanium dioxide in the rutile or brookite modification (see R. Benedix et al., Lacer No. 5, 2000, pages 157 to 167). Customarily, therefore, in order to suppress aforementioned photocatalytic effects, the titanium dioxide in the rutile modification, used as the most common white pigment, or, if used, titanium dioxide in the brookite modification, is coated with metal oxides, such as silicon oxides, aluminum oxides and/or zirconium oxides, for example. As well as the hydrophilic properties, the surfaces of the coating materials comprising anatase and also the other photocatalytically active pigments frequently also exhibit antimicrobial properties. Coating materials comprising anatase and/or the other photocatalytically active pigments, and the hydrophilic and antimicrobial properties of such materials, and also the use thereof in soiling-resistant surfaces, have been described before in numerous instances (in this regard see, for example, the following Japanese patent applications with the application numbers: 10-051556 (Isamu Paint Co. Ltd.), 11-216663 (Toto Ltd.), 11-044054 (Matsushita Electric Works Ltd.), 2000-260187 (Toto Ltd.).

A problematic feature of the use of photocatalytically active pigments, particularly of the favorably priced anatase, in coating materials which comprise organic binders, is that the organic binder, generally a polymeric compound, is attacked by the photocatalytic effects, and the organic binder is degraded. In the wake of this process, particles of pigment and filler at the surface of the coating material are exposed, leading to the unwanted phenomenon known as chalking (in this regard see R. Benedix et al., Lacer No. 5, 2000, page 161 and also R. Baumstark and M. Schwartz, Dispersionen für Bautenfarben, Acrylatsysteme in Theorie und Praxis, page 64, Curt R. Vincentz Verlag, Hannover, 2001). Additionally it is known that these coating materials have an increased tendency toward yellowing reactions. These effects have to date prevented the use of organic binders in this field, and necessitate the use of purely inorganic binders, such as waterglass, for example, which are not subject to any such degradation [see, for example, the Japanese patent application with the application number 10-309419 (Nippon Paint Co. Ltd.)].

It was an object of the present invention to provide aqueous coating materials based on organic binders and photocatalytically active pigments, particularly based on anatase, whose surfaces exhibit hydrophilic and/or antimicrobial properties, i.e., soiling-resistant properties, and at the same time display a reduced chalking and yellowing tendency.

This object has been achieved by the provision of the aqueous coating material defined at the outset. With particular advantage the object has been achieved by the provision of an aqueous coating material comprising as pulverulent pigment titanium dioxide in the anatase modification.

Composite particles having an average size ≧10 nm and ≦500 nm and composed of addition polymer and finely divided inorganic solid, particularly in the form of their aqueous dispersions, are common knowledge. These are fluid systems which in the form of a disperse phase in an aqueous dispersion medium comprise, in disperse distribution, particles composed of polymer coils, themselves consisting of a plurality of interpenetrating chains of addition polymer, referred to as the polymer matrix, and of finely divided inorganic solid. The average diameter of the composite particles is frequently in the range ≧10 nm and ≦400 nm, preferably in the range from ≧50 nm and ≦400 nm and with particular preference in the range ≧100 nm and ≦400 nm. The stated average particle diameters for the purposes of this specification are the d₅₀ figures, as they are known, which are determined via the method of the analytical ultracentrifuge (in this regard cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Mächtle, pages 147 to 175).

Composite particles and processes for preparing them in the form of aqueous composite-particle dispersions, and also the use thereof, are known to the skilled worker and are disclosed, for example, in specifications U.S. Pat. No. 3,544,500, U.S. Pat. No. 4,421,660, U.S. Pat. No. 4,608,401, U.S. Pat. No. 4,981,882, EP-A 104 498, EP-A 505 230, EP-A 572 128, GB-A 2 227 739, WO 0118081, WO 0129106, WO 03000760 and also in Long et al., Tianjin Daxue Xuebao 1991, 4, pages 10 to 15, Bourgeat-Lami et al., Die Angewandte Makromolekulare Chemie 1996, 242, pages 105 to 122, Paulke et al., Synthesis Studies of Paramagnetic Polystyrene Latex Particles in Scientific and Clinical Applications of Magnetic Carriers, pages 69 to 76, Plenum Press, New York, 1997 and Armes et al., Advanced Materials 1999,11, No.5, pages 408 to 410.

In accordance with the invention it is possible to use any composite particles, including for example those obtainable in accordance with the prior art specified above. These composite particles can be used in powder form or in an aqueous medium, as an aqueous composite-particle dispersion. Preferably, however, the composite particles are used in the form of an aqueous composite-particle dispersion.

Aqueous composite-particle dispersions suitable for the coating materials of the invention include advantageously those which have been prepared by a procedure disclosed in WO 03000760—expressly incorporated by reference into this specification. Distinctively in that process at least one ethylenically unsaturated monomer is dispersely distributed in an aqueous medium and is polymerized by means of at least one free-radical polymerization initiator in the presence of at least one dispersely distributed, finely divided inorganic solid and at least one dispersant by the method of free-radical aqueous emulsion polymerization, where
a) a stable aqueous dispersion of the at least one inorganic solid is used, said dispersion having the characteristic features that at an initial solids concentration of ≧1% by weight, based on the aqueous dispersion of the at least one inorganic solid, it still comprises in dispersed form one hour after its preparation more than 90% by weight of the originally dispersed solid, and its dispersed solid particles have a weight-average diameter ≦100 nm,
b) the dispersed particles of the at least one inorganic solid exhibit a nonzero electrophoretic mobility in an aqueous standard potassium chloride solution at a pH which corresponds to the pH of the aqueous dispersion medium before the addition of the dispersants is commenced,
c) at least one anionic, cationic and nonionic dispersant is added to the aqueous dispersion of solid particles before the addition of the at least one ethylenically unsaturated monomer is commenced,
d) thereafter, of the total amount of the at least one monomer, 0.01% to 30% by weight are added to the aqueous dispersion of solid particles and polymerization is carried out to a conversion of at least 90%
and
e) subsequently the remainder of the at least one monomer is added continuously under polymerization conditions in accordance with the rate of its consumption.

Suitable finely divided inorganic solids for this process are all those which form stable aqueous dispersions which at an initial solids concentration of ≧1% by weight, based on the aqueous dispersion of the at least one inorganic solid, still comprise in dispersed form one hour after their preparation, without stirring or shaking, more than 90% by weight of the originally dispersed solid and whose dispersed solid particles have a diameter ≦100 nm and, moreover, at a pH which corresponds to the pH of the aqueous reaction medium before the addition of the dispersants is commenced, exhibit a nonzero electrophoretic mobility.

The quantitative determination of the initial solids concentration and of the solids concentration after one hour, and also the determination of the particle diameters, take place likewise via the method of the analytical ultracentrifuge.

The method of determining the electrophoretic mobility is known to the skilled worker (cf. e.g. R. J. Hunter, Introduction to modern Colloid Science, section 8.4, pages 241 to 248, Oxford University Press, Oxford, 1993 and also K. Oka and K. Furusawa, in Electrical Phenomena at Interfaces, Surfactant Science Series, Vol. 76, chapter 8, pages 151 to 232, Marcel Dekker, New York, 1998). The electrophoretic mobility of the solid particles dispersed in the aqueous reaction medium is measured using a commercially customary electrophoresis instrument, such as, for example, the Zetasizer 3000 from Malvern Instruments Ltd., at 20° C. and 1 bar (absolute). For this purpose the aqueous dispersion of solid particles is diluted with a pH-neutral 10 millimolar (mM) aqueous potassium chloride solution (standard potassium chloride solution) until the concentration of solid particles is about 50 to 100 mg/l. The adjustment of the sample to the pH possessed by the aqueous reaction medium before the addition of the dispersants is commenced is accomplished using the customary inorganic acids, such as dilute hydrochloric acid or nitric acid, for example, or bases, such as dilute sodium hydroxide solution or potassium hydroxide solution, for example. The migration of the dispersed solid particles in the electrical field is detected by means of what is known as electrophoretic light scattering (cf., e.g., B. R. Ware and W. H. Flygare, Chem. Phys. Lett. 1971, 12, pages 81 to 85). In this method the sign of the electrophoretic mobility is defined by the migrational direction of the dispersed solid particles; in other words, if the dispersed solid particles migrate to the cathode then their electrophoretic mobility is positive, while if they migrate to the anode then it is negative.

A suitable parameter for influencing or adjusting to a certain extent the electrophoretic mobility of dispersed solid particles is the pH of the aqueous reaction medium. Protonation or deprotonation, respectively, of the dispersed solid particles alters the electrophoretic mobility in a positive direction in the acidic pH range (pH<7) and in a negative direction in the alkaline range (pH>7). A pH range suitable for the process disclosed in WO 03000760 is that within which a free-radically initiated aqueous emulsion polymerization can be carried out. This pH range is generally from 1 to 12, frequently from 1.5 to 11 and often from 2 to 10.

The pH of the aqueous reaction medium may be adjusted by means of commercially customary acids, such as dilute hydrochloric, nitric or sulfuric acid, for example, or bases, such as dilute aqueous sodium hydroxide or potassium hydroxide solution, for example. It is frequently favorable if a portion or the entirety of the amount of acid or base used for pH adjustment is added to the aqueous reaction medium before the at least one finely divided inorganic solid.

It is advantageous for the process disclosed according to WO 03000760 that, when under the aforementioned pH conditions the dispersed solid particles
have an electrophoretic mobility with a negative sign, per 100 parts by weight of the at least one ethylenically unsaturated monomer, 0.01 to 10 parts by weight, preferably 0.05 to 5 parts by weight and with particular preference 0.1 to 3 parts by weight of at least one cationic dispersant, 0.01 to 100 parts by weight, preferably 0.05 to 50 parts by weight and with particular preference 0.1 to 20 parts by weight of at least one nonionic dispersant and at least one anionic dispersant are used, the amount of the latter being such that the equivalent ratio of anionic to cationic dispersant is greater than 1, or
have an electrophoretic mobility with a positive sign, per 100 parts by weight of the at least one ethylenically unsaturated monomer, 0.01 to 10 parts by weight, preferably 0.05 to 5 parts by weight and with particular preference 0.1 to 3 parts by weight of at least one anionic dispersant, 0.01 to 100 parts by weight, preferably 0.05 to 50 parts by weight and with particular preference 0.1 to 20 parts by weight of at least one nonionic dispersant and at least one cationic dispersant are used, the amount of the latter being such that the equivalent ratio of cationic to anionic dispersant is greater than 1.

By equivalent ratio of anionic to cationic dispersant is meant the ratio of the number of moles of anionic dispersant used, multiplied by the number of anionic groups comprised per mole of the anionic dispersant, divided by the number of moles of the cationic dispersant used, multiplied by the number of cationic groups comprised per mole of the cationic dispersant. Similar considerations apply to the equivalent ratio of cationic to anionic dispersant.

The entirety of the at least one anionic, cationic and nonionic dispersant used in accordance with WO 03000760 can be included in the initial charge in the aqueous dispersion of solids. It is, however, also possible to include only a portion of the aforementioned dispersants in the initial charge, in the aqueous dispersion of solids, and to add the remaining amounts, continuously or discontinuously, during the free-radical emulsion polymerization. It is essential to the process, however, that before and during the free-radically initiated emulsion polymerization the aforementioned equivalent ratio of anionic and cationic dispersants, depending on the electrophoretic sign of the finely divided solid, is maintained. If, therefore, inorganic solid particles are used which under the aforementioned pH conditions have an electrophoretic mobility with negative sign, then the equivalent ratio of anionic to cationic dispersant throughout the emulsion polymerization must be greater than 1. Correspondingly, in the case of inorganic solid particles having an electrophoretic mobility with a positive sign, the equivalent ratio of cationic to anionic dispersant throughout the emulsion polymerization must be greater than 1. It is favorable if the equivalent ratios are ≧2, ≧3, ≧4, ≧5, ≧6, ≧7, or ≧10, the equivalent ratios in the range between 2 and particularly favorable.

Finely divided inorganic solids which can be used for the process disclosed in WO 03000760, and generally for the preparation of composite particles, are metals, metal compounds, such as metal oxides and metal salts, and also semimetal compounds and nonmetal compounds. Finely divided metal powders which can be used are noble metal colloids, such as palladium, silver, ruthenium, platinum, gold and rhodium, for example, and alloys comprising them. Examples that may be mentioned of finely divided metal oxides include titanium dioxide (available commercially, for example, as Hombitec® grades from Sachtleben Chemie GmbH), zirkonium(IV) oxide, tin(II) oxide, tin(IV) oxide (available commercially, for example, as Nyacol® SN grades from Akzo-Nobel), aluminum oxide (available commercially, for example, as Nyacol® AL grades from Akzo-Nobel), barium oxide, magnesium oxide, various oxides of iron, such as iron(II) oxide (wuestite), iron(III) oxide (hematite) and iron (II/III) oxide (magnetite), chromium(III) oxide, antimony(III) oxide, bismuth(III) oxide, zinc oxide (available commercially, for example, as Sachtotec® grades from Sachtleben Chemie GmbH), nickel(II) oxide, nickel(III) oxide, cobalt(II) oxide, cobalt(III) oxide, copper(II) oxide, yttrium(III) oxide (available commercially, for example, as Nyacol® YTTRIA grades from Akzo-Nobel), cerium(IV) oxide (available commercially, for example, as Nyacol® CEO2 grades from Akzo-Nobel), amorphous and/or in their different crystal modifications, and also their hydroxy oxides, such as hydroxytitanium(IV) oxide, hydroxyzirconium(IV) oxide, hydroxyaluminum oxide (available commercially, for example, as Disperal® grades from Condea-Chemie GmbH) and hydroxyiron(III) oxide, amorphous and/or in their different crystal modifications. The following metal salts, amorphous and/or in their different crystal structures, can be used in principle in the process of the invention: sulfides, such as iron(II) sulfide, iron(III) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, bismuth(III) sulfide, hydroxides, such as tin(II) hydroxide, aluminum hydroxide, magnesium hydroxide, calcium hydroxide, barium hydroxide, zinc hydroxide, iron(II) hydroxide, iron(III) hydroxide, sulfates, such as calcium sulfate, strontium sulfate, barium sulfate, lead(IV) sulfate, carbonates, such as lithium carbonate, magnesium carbonate, calcium carbonate, zinc carbonate, zirconium(IV) carbonate, iron(II) carbonate, iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, iron(III) orthophosphate, metaphosphates, such as lithium metaphosphate, calcium metaphosphate, aluminum metaphosphate, pyrophosphates, such as magnesium pyrophosphate, calcium pyrophosphate, zinc pyrophosphate, iron(III) pyrophosphate, tin(II) pyrophosphate, ammonium phosphates, such as magnesium ammonium phosphate, zinc ammonium phosphate, hydroxylapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, phyllosilicates, such as sodium aluminum silicate and sodium magnesium silicate, especially in spontaneously delaminating form, such as, for example, Optigel® SH (trademark of Südchemie AG), Saponit® SKS-20 and Hektorit® SKS 21 (trademarks of Hoechst AG) and Laponite® RD and Laponit® GS (trademarks of Laporte Industries Ltd.), aluminates, such as lithium aluminate, calcium aluminate, zinc aluminate, borates, such as magnesium metaborate, magnesium orthoborate, oxalates, such as calcium oxalate, zirconium(IV) oxalate, magnesium oxalate, zinc oxalate, aluminum oxalate, tartrates, such as calcium tartrate, acetylacetonates, such as aluminum acetylacetonate, iron(III) acetylacetonate, salicylates, such as aluminum salicylate, citrates, such as calcium citrate, iron(II) citrate, zinc citrate, palmitates, such as aluminum palmitate, calcium palmitate, magnesium palmitate, stearates, such as aluminum stearate, calcium stearate, magnesium stearate, zinc stearate, laurates, such as calcium laurate, linoleates, such as calcium linoleate and oleates, such as calcium oleate, iron(II) oleate or zinc oleate.

As an essential semimetal compound which can be used in accordance with the invention mention may be made of amorphous silicon dioxide and/or of silicon dioxide present in different crystal structures. Silicon dioxide suitable in accordance with the invention is available commercially and can be obtained, for example, as Aerosil® (trademark of Degussa AG), Levasil® (trademark of Bayer AG), Ludox® (trademark of DuPont), Nyacol® and Bindzil® (trademarks of Akzo-Nobel) and Snowtex® (trademark of Nissan Chemical Industries, Ltd.). Nonmetal compounds suitable in accordance with the invention are, for example, colloidal graphite or diamond.

Particularly suitable finely divided inorganic solids are those whose solubility in water at 20° C. and 1 bar (absolute) is ≦1 g/l, preferably ≦0.1 g/l and in particular ≦0.01 g/l. Particular preference is given to compounds selected from the group comprising silicon dioxide, aluminum oxide, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium pyrophosphate, magnesium pyrophosphate, orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, phyllosilicates, such as sodium aluminum silicate and sodium magnesium silicate, especially in spontaneously delaminating form, such as, for example, Optigel® SH, Saponit® SKS-20 and Hektorit® SKS 21 and also Laponite® RD and Laponite® GS, iron(II) oxide, iron(III) oxide, iron(II/III) oxide, titanium dioxide, hydroxylapatite, zinc oxide and zinc sulfide. Special preference is given to compounds containing silicon, such as pyrogenic and/or colloidal silica, silicon dioxide sols and/or phyllosilicates. Frequently these compounds containing silicon have an electrophoretic mobility with a negative sign.

With advantage it is also possible to use the commercially available compounds of the Aerosil®, Levasil®, Ludox®, Nyacol® and Bindzil® grades (silicon dioxide), Disperal® grades (hydroxyaluminum oxide), Nyacol® AL grades (aluminum oxide), Hombitec® grades (titanium dioxide), Nyacol® SN grades (tin(IV) oxide), Nyacol® YTTRIA grades (yttrium(III) oxide), Nyacol® CEO2 grades (cerium(IV) oxide) and Sachtotec® grades (zinc oxide) in the processes of the invention.

The finely divided inorganic solids which can be used for preparing the composite particles are of a kind such that the solid particles dispersed in the aqueous reaction medium have a particle diameter of ≦100 nm. Finely divided inorganic solids used successfully are those whose dispersed particles have a diameter ≧0 nm but ≦90 nm, ≦80 nm, ≦70 nm, ≦60 nm, ≦50 nm, ≦40 nm, ≦30 nm, ≦20 nm or ≦10 nm and all values in between. Finely divided inorganic solids used advantageously are those having a particle diameter ≦50 nm. The particle diameters are determined via the method of the analytical ultracentrifuge.

The obtainability of finely divided solids is known in principle to the skilled worker and takes place, for example, through precipitation reactions or chemical reactions in the gas phase (cf. in this regard E. Matijevic, Chem. Mater. 1993, 5, pages 412 to 426; Ullmann's Encyclopedia of Industrial Chemistry, Vol. A 23, pages 583 to 660, Verlag Chemie, Weinheim, 1992; D. F. Evans, H. Wennerström in The Colloidal Domain, pages 363 to 405, Verlag Chemie, Weinheim, 1994 and R. J. Hunter in Foundations of Colloid Science, Vol. I, pages 10 to 17, Clarendon Press, Oxford, 1991).

The stable dispersion of solids is frequently prepared directly during the synthesis of the finely divided inorganic solids in the aqueous medium or, alternatively, by dispersing the finely divided inorganic solid into the aqueous medium. Depending on the way in which the finely divided inorganic solids are prepared, this is done either directly, in the case for example of precipitated or pyrogenic silicon dioxide, aluminum oxide, etc., or with the assistance of suitable auxiliary equipment, such as dispersers or ultrasound sonotrodes, for example.

Finely divided inorganic solids suitable with advantage for preparing the aqueous composite-particle dispersions are those whose aqueous dispersion, at an initial solids concentration of ≧1% by weight, based on the aqueous dispersion of the finely divided inorganic solid, still comprises in dispersed form one hour after its preparation or by stirring up or shaking up the sedimented solids, without further stirring or shaking, more than 90% by weight of the originally dispersed solid, and whose dispersed solid particles have a diameter ≦100 nm. Customary initial solids concentrations are ≦60% by weight. With advantage, however it is also possible to use initial solids concentrations ≦55% by weight, ≦50% by weight, ≦45% by weight, ≦40% by weight, ≦35% by weight, ≦30% by weight, ≦25% by weight, ≦20% by weight, ≦15% by weight, ≦10% by weight and also ≧2% by weight, ≧3% by weight, ≧4% by weight or ≧5% by weight and all values in between, based in each case on the aqueous dispersion of the finely divided inorganic solid. Based on 100 parts by weight of the at least one ethylenically unsaturated monomer, the aqueous composite-particle dispersions are frequently prepared using 1 to 1000 parts by weight, generally 5 to 300 parts by weight and often 10 to 200 parts by weight, of the at least one finely divided inorganic solid.

In the preparation of the aqueous composite-particle dispersions, in general, dispersants are used which maintain not only the finely divided inorganic solid particles but also the monomer droplets and the resultant composite particles in disperse distribution in the aqueous phase and so ensure the stability of the aqueous composite-particle dispersions that are produced. Suitable dispersants include both the protective colloids that are commonly used to carry out free-radical aqueous emulsion polymerizations, and emulsifiers.

A detailed description of suitable protective colloids is found in Houben-Weyl, Methoden der organischen Chemie, volume XIV/1, Makromolekulare Stoffe [macromolecular compounds], Georg-Thieme-Verlag, Stuttgart, 1961, pages 411 to 420.

Suitable neutral protective colloids are for example polyvinyl alcohols, polyalkylene glycols, cellulose derivatives, starch derivatives and gelatin derivatives.

Suitable anionic protective colloids, i.e., protective colloids whose dispersing component has at least one negative electrical charge, include, for example, polyacrylic acids and polymethacrylic acids and their alkali metal salts, copolymers comprising acrylic acid, methacrylic acid, 2-acrylamido-2-methylpropanesulfonic acid, 4-styrenesulfonic acid and/or maleic anhydride, and their alkali metal salts, and also alkali metal salts of sulfonic acids with high molecular mass compounds, such as polystyrene, for example.

Suitable cationic protective colloids, i.e., protective colloids whose dispersing component has at least one positive electrical charge, include, for example, the derivatives, alkylated and/or protonated on the nitrogen, of homopolymers and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amine-group-carrying acrylates, methacrylates, acrylamides and/or methacrylamides.

It is of course also possible to use mixtures of emulsifiers and/or protective colloids. Frequently use is made as dispersants exclusively of emulsifiers, whose relative molecular weights, in contradistinction to those of the protective colloids, are usually below 1500. Where mixtures of surface-active substances are used, the individual components must of course be compatible with one another, something which in case of doubt can be ascertained by means of a few preliminary tests. An overview of suitable emulsifiers is found in Houben-Weyl, Methoden der organischen Chemie, volume XIV/1, Makromolekulare Stoffe [macromolecular compounds], Georg-Thieme-Verlag, Stuttgart, 1961, pages 192 to 208.

Examples of customary nonionic emulsifiers are ethoxylated mono-, di- and tri-alkylphenols (EO degree: 3 to 50, alkyl radical: C₄ to C₁₂) and also ethoxylated fatty alcohols (EO degree: 3 to 80; alkyl radical: C₈ to C₃₆). Examples thereof are the Lutensol® A grades (C₁₂C₁₄ fatty alcohol ethoxylates, EO degree: 3 to 8), Lutensol® AO grades (C₁₃C₁₅ oxo alcohol ethoxylates, EO degree: 3 to 30), Lutensol® AT grades (C₁₆C₁₈ fatty alcohol ethoxylates, EO degree: 11 to 80), Lutensol® ON grades (C₁₀ oxo alcohol ethoxylates, EO degree 3 to 11) and the Lutensol® TO grades (C₁₃ oxo alcohol ethoxylates, EO degree: 3 to 20) of BASF AG.

Customary anionic emulsifiers are, for example, alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈) and with ethoxylated alkylphenols (EO degree: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈).

Furthermore, compounds of the general formula I 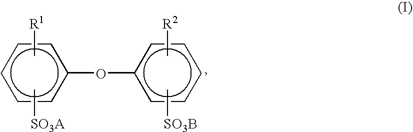
in which R¹ and R² are hydrogen atoms or C₄- to C₂₄-alkyl and are not simultaneously hydrogen atoms, and A and B can be alkali metal ions and/or ammonium ions, have proven to be further anionic emulsifiers. In the general formula I R¹ and R² are preferably linear or branched alkyl radicals having 6 to 18 carbon atoms, in particular having 6, 12 and 16 carbon atoms, or —H, R¹ and R² not both simultaneously being hydrogen atoms. A and B are preferably sodium, potassium or ammonium, with sodium being particularly preferred. Particularly advantageous compounds I are those in which A and B are sodium, R¹ is a branched alkyl radical having 12 carbon atoms and R² is a hydrogen atom or R¹. Frequently use is made of technical mixtures which have a fraction of 50% to 90% by weight of the monoalkylated product, such as Dowfax® 2A1 (trademark of Dow Chemical Company), for example. The compounds I are general knowledge, from U.S. Pat. No. 4,269,749 for example, and are available in commerce.

Suitable cation-active emulsifiers generally have a C₆ to C₁₈ alkyl, aralkyl or heterocyclic radical and are primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. By way of example mention may be made of dodecylammonium acetate or the corresponding hydrochloride, the chlorides or acetates of the various 2-(N,N,N-trimethylammonio)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N-octyl-N,N,N-trimethylammonium bromide, N,N-distearyl-N,N-dimethylammonium chloride and also the gemini surfactant N,N′-(lauryldimethyl)ethylenediamine dibromide. Numerous further examples are found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

Frequently for the purpose of preparing the aqueous composite-particle dispersions between 0.1% to 10% by weight, often 0.5% to 7.0% by weight and frequently 1.0% to 5.0% by weight of dispersant is used, based in each case on the total amount of aqueous composite-particle dispersion. Preferably emulsifiers are used.

Suitable ethylenically unsaturated monomers for preparing the composite particles include, inter alia, particularly monomers which can be easily free-radically polymerized, such as, for example, ethylene, vinylaromatic monomers, such as styrene, α-methylstyrene, o-chlorostyrene or vinyltoluenes, esters of vinyl alcohol and monocarboxylic acids containing 1 to 18 carbon atoms, such as vinyl acetate, vinyl propionate, vinyl n-butyrate, vinyl laurate and vinyl stearate, esters of α,β-monoethylenically unsaturated monocarboxylic and dicarboxylic acids containing preferably 3 to 6 carbon atoms, such as, in particular, acrylic acid, methacrylic acid, maleic acid, fumaric acid and itaconic acid, with alkanols containing generally 1 to 12, preferably 1 to 8 and in particular 1 to 4 carbon atoms, such as methyl, ethyl, n-butyl, isobutyl and 2-ethylhexyl acrylate and methacrylate, dimethyl maleate or di-n-butyl maleate, nitriles of α,β-monoethylenically unsaturated carboxylic acids, such as acrylonitrile, and C₄₋₈ conjugated dienes, such as 1,3-butadiene and isoprene. The specified monomers generally form the principal monomers, which, based on the total amount of the monomers to be polymerized in accordance with the process of the invention, account normally for a fraction of ≧50% by weight, ≧80% by weight or ≧90% by weight. As a general rule, these monomers have only a moderate to low solubility in water under standard conditions [20° C., 1 bar (absolute)].

Monomers which customarily increase the internal strength of the films formed from the polymer matrix normally have at least one epoxy, hydroxyl, N-methylol or carbonyl group, or at least two nonconjugated ethylenically unsaturated double bonds. Examples of such are monomers having two vinyl radicals, monomers having two vinylidene radicals, and monomers having two alkenyl radicals. Particularly advantageous monomers in this context are the diesters of dihydric alcohols with α,β-monoethylenically unsaturated monocarboxylic acids, among which acrylic and methacrylic acid are preferred. Examples of monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are the C₁-C₈ hydroxyalkyl methacrylates and acrylates, such as n-hydroxyethyl, n-hydroxypropyl or n-hydroxybutyl acrylate and methacrylate, and also compounds such as diacetoneacrylamide and acetylacetoxyethyl acrylate and methacrylate. In accordance with the invention the aforementioned monomers, based on the total amount of the monomers to be polymerized, are copolymerized in amounts of up to 5% by weight, especially 0.1% to 3% by weight.

Optionally it is also possible to use ethylenically unsaturated monomers comprising siloxane groups, such as the vinyltrialkoxysilanes, vinyltrimethoxysilane for example, alkylvinyldialkoxysilanes, acryloyloxyalkyltrialkoxysilanes, or methacryloyloxyalkyl-trialkoxysilanes, such as acryloyloxyethyltrimethoxysilane, methacryloyloxyethyl-trimethoxysilane, acryloyloxypropyltrimethoxysilane or methacryloyloxypropyl-trimethoxysilane, for example. These monomers are used in amounts of up to 5% by weight, frequently 0.01% to 3% by weight and often from 0.05% to 1% by weight, based in each case on the total monomer amount. Advantageous in accordance with the invention are coating materials whose addition polymers comprise in copolymerized form aforementioned monomers comprising siloxane groups at 0.01% to 5% by weight, in particular 0.01% to 3% by weight and preferably 0.05% to 1.5% by weight.

In addition it is possible to use as monomers as well those ethylenically unsaturated monomers A which comprise either at least one acid group and/or the corresponding anion thereof, or those ethylenically unsaturated monomers B which comprise at least one amino, amido, ureido or N-heterocyclic group and/or the ammonium derivatives thereof that are alkylated or protonated on the nitrogen. Based on the total monomer amount, the amount of monomers A or of monomers B is up to 10% by weight, often 0.1% to 7% by weight and frequently 0.2% to 5% by weight.

As monomers A use is made of ethylenically unsaturated monomers having at least one acid group. The acid group in this case may be, for example, a carboxylic acid, sulfonic acid, sulfuric acid, phosphoric acid and/or phosphonic acid group. Examples of monomers A are acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid and also phosphoric monoesters of n-hydroxyalkyl acrylates and n-hydroxyalkyl methacrylates, such as, for example, phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate. In accordance with the invention it is also possible, however, to use the ammonium salts and alkali metal salts of the aforementioned ethylenically unsaturated monomers having at least one acid group. As alkali metal particular preference is given to sodium and potassium. Examples thereof are the ammonium, sodium and potassium salts of acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid and also the mono- and di-ammonium, -sodium and -potassium salts of the phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Preference is given to using acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid.

As monomers B use is made of ethylenically unsaturated monomers which comprise at least one amino, amido, ureido or N-heterocyclic group and/or the ammonium derivatives thereof that are alkylated or protonated on the nitrogen.

Examples of monomers B which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methyl-amino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (available commercially, for example, as Norsocryl® TBAEMA from Elf Atochem), 2-(N,N-dimethylamino)ethyl acrylate (available commercially, for example, as Norsocryl® ADAME from Elf Atochem), 2-(N,N-dimethylamino)ethyl methacrylate (available commercially, for example, as Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N, N-di-n-propylamino)propyl methacrylate, 3-(N,N-diisopropylamino)propyl acrylate and 3-(N,N-diisopropylamino)propyl methacrylate.

Examples of monomers B which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropylmethacrylamide, N,N-di-n-butylacrylamide, N,N-di-n-butylmethacrylamide, N-(3-N′,N′-dimethylamino-propyl)methacrylamide, diacetoneacrylamide, N,N′-methylenebisacrylamide, N-(diphenylmethyl)acrylamide, N-cyclohexylacrylamide, but also N-vinylpyrrolidone and N-vinylcaprolactam.

Examples of monomers B which comprise at least one ureido group are N,N′-divinylethyleneurea and 2-(1-imidazolin-2-onyl)ethyl methacrylate (available commercially, for example, as Norsocryl® 100 from Elf Atochem).

Examples of monomers B which comprise at least one N-heterocyclic group are 2-vinylpyridine, 4-vinylpyridine, 1-vinylimidazole, 2-vinylimidazole and N-vinylcarbazole.

Preference is given to using the following compounds: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethyl-aminopropyl)methacrylamide and 2-(1-imidazolin-2-onyl)ethyl methacrylate.

Depending on the pH of the aqueous reaction medium it is possible for a portion or the entirety of the aforementioned nitrogen-containing monomers B to be present in the quaternary ammonium form protonated on the nitrogen.

As monomers B which have a quaternary alkylammonium structure on the nitrogen mention may be made, by way of example, of 2-(N,N,N-trimethylammonio)ethyl acrylate chloride (available commercially, for example, as Norsocryl® ADAMQUAT MC 80 from Elf Atochem), 2-(N,N,N-trimethylammonio)ethyl methacrylate chloride (available commercially, for example, as Norsocryl® MADQUAT MC 75 from Elf Atochem), 2-(N-methyl-N,N-diethylammonio)ethyl acrylate chloride, 2-(N-methyl-N,N-diethylammonio)ethyl methacrylate chloride, 2-(N-methyl-N,N-dipropyl-ammonio)ethyl acrylate chloride, 2-(N-methyl-N,N-dipropylammonio)ethyl methacrylate, 2-(N-benzyl-N,N-dimethylammonio)ethyl acrylate chloride (available commercially, for example, as Norsocryl® ADAMQUAT BZ 80 from Elf Atochem), 2-(N-benzyl-N,N-dimethylammonio)ethyl methacrylate chloride (available commercially, for example, as Norsocryl® MADQUAT BZ 75 from Elf Atochem), 2-(N-benzyl-N,N-diethylammonio)-ethyl acrylate chloride, 2-(N-benzyl-N,N-diethylammonio)ethyl methacrylate chloride, 2-(N-Benzyl-N,N-dipropylammonio)ethyl acrylate chloride, 2-(N-benzyl-N,N-dipropylammonio)ethyl methacrylate chloride, 3-(N,N,N-trimethylammonio)propyl acrylate chloride, 3-(N,N,N-trimethylammonio)propyl methacrylate chloride, 3-(N-methyl-N,N-diethylammonio)propyl acrylate chloride, 3-(N-methyl-N,N-diethylammonio)propyl methacrylate chloride, 3-(N-methyl-N,N-dipropylammonio)-propyl acrylate chloride, 3-(N-methyl-N,N-dipropylammonio)propyl methacrylate chloride, 3-(N-benzyl-N,N-dimethylammonio)propyl acrylate chloride, 3-(N-benzyl-N,N-dimethylammonio)propyl methacrylate chloride, 3-(N-benzyl-N,N-diethylammonio)-propyl acrylate chloride, 3-(N-benzyl-N,N-diethylammonio)propyl methacrylate chloride, 3-(N-benzyl-N,N-dipropylammonio)propyl acrylate chloride and 3-(N-benzyl-N,N-dipropylammonio)propyl methacrylate chloride. Of course it is possible in lieu of the specified chlorides to use the corresponding bromides and sulfates as well.

Preference is given to using 2-(N,N,N-trimethylammonio)ethyl acrylate chloride, 2-(N,N,N-trimethylammonio)ethyl methacrylate chloride, 2-(N-benzyl-N,N-dimethylammonio)ethyl acrylate chloride and 2-(N-benzyl-N,N-dimethylammonio)ethyl methacrylate chloride.

It is of course also possible to use mixtures of the aforementioned ethylenically unsaturated monomers.

It is important that for the process disclosed according to WO 03000760, where dispersed solid particles having an electrophoretic mobility with a negative sign are present, a portion or the entirety of the at least one anionic dispersant can be replaced by the equivalent amount of at least one monomer A, and, where dispersed solid particles having an electrophoretic mobility with a positive sign are present, a portion or the entirety of the at least one cationic dispersant can be replaced by the equivalent amount of at least one monomer B.

Suitable free-radical polymerization initiators for preparing the aqueous composite-particle dispersion by means of free-radical polymerization include all those capable of initiating a free-radical aqueous emulsion polymerization. These may in principle be not only peroxides but also azo compounds. Redox initiator systems too are also suitable, of course. As peroxides it is possible in principle to use inorganic peroxides, such as hydrogen peroxide or peroxodisulfates, such as the mono- or di-alkali metal salts or ammonium salts of peroxodisulfuric acid, such as its mono- and di-sodium, -potassium or ammonium salts, for example, or organic peroxides, such as alkyl hydroperoxides, tert-butyl, p-menthyl, or cumyl hydroperoxide for example, and also dialkyl or diaryl peroxides, such as di-tert-butyl peroxide or dicumyl peroxide. Compounds which find use as an azo compound include essentially 2,2′-azobis(isobutyronitrile), 2,2′-azobis(2,4-dimethylvaleronitrile) and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use sulfur compounds with a low oxidation state, such as alkali metal sulfites, examples being potassium and/or sodium sulfite, alkali metal hydrogen sulfites, examples being potassium and/or sodium hydrogen sulfite, alkali metal metabisulfites, examples being potassium and/or sodium metabisulfite, formaldehyde-sulfoxylates, examples being potassium and/or sodium formaldehyde-sulfoxylate, alkali metal salts, especially potassium and/or sodium salts of aliphatic sulfinic acids and alkali metal hydrogen sulfides, such as potassium and/or sodium hydrogen sulfide, for example, salts of polyvalent metals, such as iron(II) sulfate, iron(II) ammonium sulfate, iron(II) phosphate, endiols, such as dihydroxymaleic acid, benzoin and/or ascorbic acid, and also reducing saccharides, such as sorbose, glucose, fructose and/or dihydroxyacetone. In general the amount of free-radical polymerization initiator used, based on the total amount of the monomer mixture, is 0.1% to 5% by weight.

A suitable reaction temperature for the free-radical aqueous polymerization reaction in the presence of the finely divided inorganic solid encompasses the entire range from 0 to 170° C. Generally temperatures of 50 to 120° C., frequently 60 to 110° C. and often ≧70 to 100° C. are employed. The free-radical aqueous emulsion polymerization can be carried out at a pressure smaller than, equal to or greater than 1 bar (absolute), in which case the polymerization temperature may exceed 100° C. and may be up to 170° C. Volatile monomers such as ethylene, butadiene or vinyl chloride are preferably polymerized under superatmospheric pressure. In that case the pressure may be 1.2, 1.5, 2, 5, 10, or 15 bar or even higher. Where emulsion polymerizations are carried out under subatmospheric pressure, pressures of 950 mbar, frequently of 900 mbar and often 850 mbar (absolute) are set. Advantageously the free-radical aqueous polymerization is carried out at 1 bar (absolute) under an inert gas atmosphere, such as under nitrogen or argon, for example.

The aqueous reaction medium may in principle also comprise, to a minor extent, water-soluble organic solvents, such as, for example, methanol, ethanol, isopropanol, butanols, pentanols, but also acetone, etc. Preferably, however, the polymerization reaction takes place in the absence of such solvents

In addition to the aforementioned components, it is also possible, optionally, in the processes for preparing the aqueous composite-particle dispersion, to use radical chain transfer compounds in order to reduce and/or control the molecular weight of the polymers that are obtainable by means of the polymerization. Compounds used are essentially aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, examples being ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, for example, aromatic thiols, such as benzenethiol, ortho-, meta-, or para-methylbenzenethiol, and also all further sulfur compounds described in the Polymer Handbook, 3rd edition, 1989, J. Brandrup and E. H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes having nonconjugated double bonds, such as divinylmethane or vinylcyclohexane or hydrocarbons having readily abstractable hydrogen atoms, such as toluene, for example. It is also possible, however to use mixtures of noninterfering radical chain transfer compounds mentioned above. The total amount optionally used of the radical chain transfer compounds, based on the total amount of the monomers to be polymerized, is in general ≦5% by weight, often ≦3% by weight and frequently ≦1% by weight.

The aqueous composite-particle dispersions used in accordance with the invention normally have a total solids content of 1% to 70% by weight, frequently of 5% to 65% by weight and often of 10% to 60% by weight.

The composite particles which can be used in accordance with the invention may have different structures. The composite particles may comprise one or more of the finely divided solid particles. The finely divided solid particles may be enveloped completely by the polymer matrix. It is, however, also possible for some of the finely divided solid particles to be enveloped by the polymer matrix while some others are disposed on the surface of the polymer matrix. Of course it is also possible for a major fraction of the finely divided solid particles to be bound on the surface of the polymer matrix.

It is favorable if the composite particles used for the coating material of the invention have a finely divided inorganic solid content of ≧10% by weight, preferably ≧15% by weight and with particular preference ≧20% by weight.

Frequently use is made in particular of those composite particles which, or of composite-particle dispersions whose composite particles, are composed of addition polymers which can be filmed and whose minimum film formation temperature is ≦150° C., preferably ≦100° C. and more preferably ≦50° C. Since it is no longer possible to measure the minimum film formation temperature below 0° C., the lower limit of the minimum film formation temperature can be indicated only by means of the glass transition temperature. The glass transition temperatures should not be below −60° C., preferably −30° C. or −15° C. Frequently the glass transition temperatures are in the region ≦150° C., preferably in the region ≦100° C. and more preferably in the region ≦50° C. The minimum film formation temperature is determined in accordance with DIN 53 787 or ISO 2115 and the glass transition temperature in accordance with DIN 53 765 (differential scanning calorimetry, 20 K/min, midpoint measurement).

According to Fox (T. G. Fox, Bull. Am. Phys. Soc. 1956 [Ser. II] 1, page 123 and in accordance with Ullmann's Encyclopädie der technischen Chemie, vol. 19, page 18, 4th edition, Verlag Chemie, Weinheim, 1980) the glass transition temperature T_{g} of copolymers with no more than slight levels of crosslinking is given in good approximation by:
1/T_{g}=x¹/T_{g}¹+x²/T_{g}²+ . . . xⁿ/T_{g}ⁿ,
where x¹, x², . . . xⁿ are the mass fractions of the monomers 1, 2, . . . n and T_{g}¹, T_{g}², . . . T_{g}ⁿ are the glass transition temperatures of the polymers composed in each case of only one of the monomers 1, 2 . . . n, in degrees Kelvin. The T_{g} values for the homopolymers of the majority of monomers are known and are listed for example in Ullmann's Encyclopedia of Industrial Chemistry, 5th ed., vol. A21, page 169, Verlag Chemie, Weinheim, 1992; further sources of glass transition temperatures of homopolymers include for example J. Brandrup, E. H. Immergut, Polymer Handbook, 1st ed., J. Wiley, New York, 1966; 2nd ed. J. Wiley, New York, 1975 and 3rd ed. J. Wiley, New York, 1989.

In accordance with the invention the aqueous coating material comprises 5% to 85% by weight, often 10% to 70% by weight and frequently 15% to 55% by weight of composite particles, based in each case on the solids content of the aqueous coating material.

The aqueous coating material of the invention comprises as photocatalytically active and therefore uncoated pigment at least one pulverulent pigment selected from the group comprising zinc oxide, zinc sulfide, iron(III) oxide, tin dioxide and also titanium dioxide in the rutile, anatase and brookite modification. Preference in accordance with the invention, however, is given to using titanium dioxide in the anatase modification.

Besides the anatase, the coating material that is preferred in accordance with the invention frequently further comprises at least one further pulverulent pigment and/or at least one pulverulent filler. Pulverulent for the purposes of this specification should be regarded as referring to all pigments having an average primary particle size ≦1 μm (determined by light scattering methods familiar to the skilled worker; ISO 13321) and all fillers ≦100 μm (determined, for example, by sieving at corresponding mesh size).

Also in accordance with the claims, of course, are all those so-called aqueous pigment slurries and/or filler slurries which comprise pulverulent fillers and/or pulverulent pigments dispersed in an aqueous medium.

With preference in accordance with the invention the aqueous coating material comprises 0.05% to 20% by weight, often 0.5% to 10% by weight and frequently 1% to 8% by weight of anatase, based in each case on the solids content of the aqueous coating material.

As at least one further pulverulent pigment it is possible in principle to use all non-anatase pigments referred to as white pigments or chromatic pigments.

The most important further white pigment, on the basis of its high refractive index and its good opacity, is titanium dioxide in the form of its brookite and rutile modifications. Zinc oxide and zinc sulfide, however, are also used as white pigments. Titanium dioxide in the form of its brookite and rutile modifications can be used in surface-coated form (i.e., coated and therefore in photocatalytically inactive form) or uncoated form (i.e., not coated and therefore in photocatalytically active form). As at least one further white pigment use is made in particular of titanium dioxide in the form of its rutile modification in a coated form. Additionally, however, organic white pigments are used, such as, for example, nonfilming, hollow addition-polymer particles rich in styrene and carboxyl groups and having a particle size of about 300 to 400 nm (known as opaque particles).

Besides white pigments, a very wide variety of chromatic pigments familiar to the skilled worker can be used to color the coating material, examples being the somewhat more favorably priced inorganic iron, cadmium, chromium and lead oxides and sulfides, lead molybdate, cobalt blue or carbon black, and also the somewhat more expensive organic pigments, examples being phthalocyanines, azo pigments, quinacridones, perylenes or carbazoles.

In particular, however, titanium dioxide in the rutile modification is used as further white pigment. With particular advantage this titanium dioxide is used in a surface coated with metal oxides (for example, Kronos® 2190 or Kronos® 2044 from Kronos Titan GmbH or Tronox® CR 828 from Kerr & McGee Pigments GmbH & Co. KG).

In general the aqueous coating material preferred in accordance with the invention comprises a total amount of 5% to 60% by weight, often 10% to 50% by weight and frequently 20% to 45% by weight of further pigments other than anatase, based in each case on the solids content of the aqueous coating material.

As at least one pulverulent filler use is made essentially of inorganic materials having a lower refractive index than that of the pigments. These pulverulent fillers are frequently minerals which occur naturally, such as calcite, chalk, dolomite, kaolin, talc, mica, diatomaceous earth, barytes, quarz or talc/chlorite intergrowths, for example, but also inorganic compounds prepared synthetically, such as precipitated calcium carbonate, calcined kaolin or barium sulfate, for example, and also pyrogenic silica. As filler it is preferred to use calcium carbonate in the form of crystalline calcite or of amorphous chalk.

In general the aqueous coating material of the invention comprises a total amount of 0% to 80% by weight, often 1% to 60% by weight and frequently 3% to 40% by weight of pulverulent fillers, based in each case on the solids content of the aqueous coating material.

It is of advantage if the aqueous coating material of the invention has a pigment volume concentration (PVC) ≧10%, often ≧20%, ≧30% or ≧40% and frequently ≦60%, ≦70% or ≦80%. Depending on the field of use it is possible, for example, to set PVCs of ≧35% and ≦60% (masonry paints), ≧20% and ≦40% (wood paints), ≧15% and ≦25% (gloss paints), ≧40% and ≦80% (interior paints) or ≧80% and ≦95% (synthetic-resin renders). For the skilled worker the PVC is one of the key variables for characterizing coating materials, especially paints. The PVC is the arithmetic description of the volume fraction of the pulverulent pigments, pulverulent fillers and also finely divided inorganic solids as proportion of the total volume of the dried coating material (coating). The PVC is calculated as indicated in the following equation:

$$\% PVC = \frac{\begin{matrix}volume of the pigments , \\ fillers and finely divided inorganic solids ⨯ 100\end{matrix}}{\begin{matrix}volume of polymeric binder + volume of pigments , \\ fillers and finely divided inorganic soilds\end{matrix}}$$

Essential for the understanding of the present invention is that, the higher the formulated PVC of the coating material, the lower the polymeric binder (=addition polymer of the composite particles) content of the coating material.

Advantageous aqueous coating materials comprise

5% to 85% by weight of composite particles,

0.05% to 20% by weight of pulverulent titanium dioxide in the anatase modification,

5% to 60% by weight of further pulverulent pigments,

0% to 80% by weight of pulverulent fillers, and

0% to 10% by weight of further customary auxiliaries,

based in each case on the solids content of the aqueous coating material.

Where the coating material of the invention is to be used, for example, as a masonry paint, it comprises advantageously

25% to 55% by weight of composite particles,

1% to 8% by weight of pulverulent titanium dioxide in the anatase modification,

20% to 45% by weight of further pulverulent pigments,

3% to 30% by weight of pulverulent fillers, and

0.05% to 5% by weight of further customary auxiliaries,

based in each case on the solids content of the aqueous coating material.

If, on the other hand, the coating material of the invention is to be used, for example, as an interior paint, then it comprises advantageously

5% to 35% by weight of composite particles,

0.1% to 8% by weight of pulverulent titanium dioxide in the anatase modification,

5% to 35% by weight of further pulverulent pigments,

25% to 60% by weight of pulverulent fillers, and

0.05% to 5% by weight of further customary auxiliaries,

based in each case on the solids content of the aqueous coating material.

If the coating material of the invention is to be used, for example, as a synthetic-resin render, then it advantageously comprises

5% to 25% by weight of composite particles,

0.1% to 5% by weight of pulverulent titanium dioxide in the anatase modification,

5% to 15% by weight of further pulverulent pigments,

40% to 80% by weight of pulverulent fillers, and

0.05% to 5% by weight of further customary auxiliaries,

based in each case on the solids content of the aqueous coating material.

Further customary auxiliaries comprised in accordance with the invention include, for example, what are called pigment dispersing assistants, film-forming assistants, thickeners, defoamers, wetting and dispersing assistants, neutralizing agents and/or preservatives. The total amount of further customary auxiliaries is generally ≦10% by weight, or ≦5% by weight, based in each case on the solids content of the aqueous coating material.

Film-forming assistants, also called coalescents, are used in order to allow even polymeric binders having a glass transition temperature of more than 20° C. to film reliably at room temperature. These film-forming assistants improve the film formation of the polymeric binder during the formation of the coating and are then subsequently emitted to the environment from the coating, depending on the ambient temperature, the atmospheric humidity and the boiling point, and also on the vapor pressure resulting therefrom. The film-forming assistants which are known to the skilled worker comprise, for example, white spirit, water-miscible glycol ethers, such a butyl glycol, butyl diglycol, dipropylene glycol monomethyl ether or dipropylene glycol butyl ether, and also glycol acetates, such as butyl glycol acetate, butyl diglycol acetate, but also esters of carboxylic acids and dicarboxylic acids, such as 2-ethylhexyl benzoate, 2,2,4-trimethylpentane-1,3-diol monoisobutyrate or tripropylene glycol monoisobutyrate.

In order to set optimally the rheology of aqueous coating materials during preparation, handling, storage and application it is common to use what are known as thickeners or rheological additives as a formulation ingredient. The skilled worker is aware of a multiplicity of different thickeners, examples being organic thickeners, such as xanthan thickeners, guar thickeners (polysaccharides), carboxymethylcellulose, hydroxyethylcellulose, methylcellulose, hydroxypropylmethylcellulose, ethylhydroxyethylcellulose (cellulose derivatives), alkali-swellable dispersions (acrylate thickeners) or hydrophobically modified, polyether-based polyurethanes (polyurethane thickeners) or inorganic thickeners, such as bentonite, hectorite, smectite, attapulgite (Bentone) and also titanates or zirconates (metal organyls).

In order to avoid the formation of foam during preparation, handling, storage and application of the aqueous coating materials, use is made of agents known as defoamers. The defoamers are familiar to the skilled worker. The defoamers involved here are essentially mineral oil defoamers and the silicone oil defoamers. Defoamers, especially the highly active silicone varieties, must generally be selected and metered with great care, since they can lead to surface defects (craters, dimples, etc.) in the coating. It is significant that by adding very finely divided, hydrophobic particles, of hydrophobic silica or wax particles, for example, to the defoamer liquid it is possible to increase the defoaming effect still further.

Wetting and dispersing assistants are used in order to bring about optimum distribution of the pulverulent pigments and fillers in the aqueous coating material. The wetting and dispersing assistants assist the dispersing operation by facilitating the wetting of the pulverulent pigments and fillers in the aqueous dispersion medium (wetting agent effect), by breaking up powder agglomerates (splitting effect) and by steric and/or electrostatic stabilization of the primary particles of pigment and filler that are produced in the course of the shearing operation (dispersant effect). Compounds used as wetting and dispersing assistants are, in particular, the polyphosphates and salts of polycarboxylic acids that are familiar to the skilled worker, especially sodium salts of polyacrylic acids and/or acrylic acid copolymers.

If necessary, acids or bases familiar to the skilled worker as neutralizing agents, examples being bases based on hydroxyl-containing alkylamino compounds (see in this regard the applicant's German patent application with the file reference DE 102004010155.8, unpublished at the priority date of the present specification), can be used for adjusting the pH of the aqueous coating material.

In order to avoid the infestation of the aqueous coating materials during preparation, handling, storage and application by microorganisms, such as bacteria, (mold) fungi or yeasts, for example, preservatives or biocides familiar to the skilled worker are frequently used. Use is made here in particular of active substance combinations of methyl- and chloroisothiazolinones, benzisothiazolinones, formaldehyde and formaldehyde donor agents.

Besides aforementioned auxiliaries, further auxiliaries familiar to the skilled worker, such as matting agents, waxes or flow assistants, etc., may be added to the aqueous coating materials in the course of preparation, handling, storage and application.

Furthermore it is possible in principle to mix the aqueous coating materials of the invention with hydrophobicizers, based for example on polysiloxanes or silicone resins.

The aqueous coating materials of the invention are particularly suitable for coating substrates. Substrates which can be used include for example plastics, such as polyethylene, polypropylene, polyamide, polystyrene or polyesters, metals or metal alloys, such as iron, steel, aluminum, copper or bronze, wood, paper, paperboard or mineral substrates, such as concrete, plaster, mortar, glass or ceramic, for example.

A coated substrate is produced by applying an aqueous coating material of the invention to the surface of a substrate and drying it under conditions in which the polymer forms a film. The filming conditions (pressure and temperature) are dependent in particular on the composition of the polymer (and the resultant minimum film formation temperature or glass transition temperature) and on the presence of film-forming assistants. These conditions either are familiar to the skilled worker or can be determined by him or her in a few preliminary tests. Frequently it is favorable if the polymer has a glass transition temperature in the range ≦50° C., in particular ≦30° C. or ≦20° C. and ≧−30° C., preferably ≧−15° C.

Through the provision of the aqueous coating materials of the invention success has been achieved in providing coating materials based on organic binders and photocatalytically active pigments, particularly the favorably available photocatalytic anatase, whose dried surfaces have hydrophilic and/or antimicrobial properties, i.e., soiling resistance properties, and at the same time exhibit a reduced chalking tendency. Furthermore, the surfaces coated with the coating materials of the invention display a markedly reduced yellowing tendency. The coating materials of the invention can therefore be used in particular for coating substrates in the exterior sector.

The invention is illustrated with reference to the following, nonlimiting examples.

### EXAMPLES

I Preparation of an Aqueous Composite-Particle Dispersion NK1

A 21 four-necked flask, fitted with a reflux condenser, a thermometer, a mechanical stirrer and a metering device, was charged at 20 to 25° C. (room temperature) and 1 bar (absolute) under a nitrogen atmosphere and with stirring (200 revolutions per minute) with 416.6 g of Nyacol® 2040 and subsequently with a mixture of 2.5 g of methacrylic acid and 12 g of a 10% strength by weight aqueous solution of sodium hydroxide over the course of 5 minutes. Added to the stirred reaction mixture thereafter, over 15 minutes, was a mixture of 10.4 g of a 20% strength by weight aqueous solution of the nonionic surfactant Lutensol® AT 18 (trademark of BASF AG, C₁₆C₁₈ fatty alcohol ethoxylate having 18 ethylene oxide units) and 108.5 g of deionized water. Subsequently, 0.83 g of N-cetyl-N,N,N-trimethylammonium bromide (CTAB), in solution in 200 g of deionized water, was metered into the reaction mixture over 60 minutes. Thereafter the reaction mixture was heated to a reaction temperature of 80° C.

Prepared in parallel were, as feed 1, a monomer mixture consisting of 117.5 g of methyl methacrylate (MMA), 130 g of n-butyl acrylate (n-BA) and 0.5 g of methacryloyloxypropyltrimethoxysilane (MEMO) and, as feed 2, an initiator solution consisting of 2.5 g of sodium peroxodisulfate, 7 g of a 10% strength by weight solution of sodium hydroxide and 200 g of deionized water.

Subsequently 21.1 g of feed 1 and 57.1 g of feed 2 were added via 2 separate feed lines over 5 minutes to the reaction mixture, which was stirred at reaction temperature. Thereafter the reaction mixture was stirred at reaction temperature for one hour. Subsequently 0.92 g of a 45% strength by weight aqueous solution of Dowfax® 2A1 was added to the reaction mixture. Then, over the course of 2 hours but beginning simultaneously, the remainders of feed 1 and feed 2 were metered continuously into the reaction mixture. After that the reaction mixture was stirred at reaction temperature for one hour more and then cooled to room temperature.

The aqueous composite-particle dispersion thus obtained had a solids content of 35.1% by weight, based on the total weight of the aqueous composite-particle dispersion.

The solids content was determined by drying approximately 1 g of the aqueous composite-particle dispersion to constant weight in a drying cabinet at 150° C. in an open aluminum crucible having an internal diameter of approximately 3 cm. To determine the solids content, two separate measurements were carried out in each case and the corresponding average was formed.

The amount of finely divided inorganic solid in the composite particles is calculated at 40% by weight, based on the composite particle total weight.

The addition polymer of the composite particles had a glass transition temperature of <5° C. (DIN 53 765).

The average particle diameter (d₅₀) of the composite particles, determined by the analytical ultracentrifuge method, was 65 nm.

II Preparation of Aqueous Coating Materials

Aqueous coating materials were prepared with the above-described aqueous composite-particle dispersion and also with two commercially customary aqueous polymer dispersions as polymeric binders. The commercially customary aqueous polymer dispersions used were Acronal® S 790, a styrene acrylate having a solids content of 50% by weight and a minimum film formation temperature of about 20° C., and Acronal® DS 6254, a straight acrylate having a solids content of 48% by weight and a minimum film formation temperature of about 14° C. (both sales products of BASF AG).

Regarding the formulations of the aqueous coating materials it was ensured that the pigment volume concentrations were equal. Here it should be noted that the silicon dioxide particles in the aqueous composite-particle dispersion were regarded as a filler, with a density of 2.3 g/cm³, and accordingly, as such, entered into the PVC calculation.

In order to test the photocatalytic effect, in the corresponding aqueous coating materials, the nonphotoactive (surface-coated with aluminum/zirconium oxides) rutile modification of titanium dioxide (Kronos® 2190, sales product from Kronos Titan GmbH) was replaced by different amounts of photoactive anatase modification (Hombikat® UV 100, sales product from Sachtleben Chemie GmbH).

The solids contents of coating materials V1-V9 and 10-12 were determined by drying approximately 1 g of the aqueous coating materials to constant weight in a drying cabinet at 150° C. in an open aluminum crucible having an internal diameter of approximately 3 cm. To determine the solids content, two separate measurements were carried out in each case and the corresponding average was formed.

### Comparative Examples 1-4

A pigment paste was prepared at room temperature, with stirring using a disc stirrer at 1000 revolutions per minute, from (added in the order stated): 62.5 g of deionized water, 3 g of dispersant (Pigmentverteiler A, sales product from BASF AG), 4 g of a 25% strength by weight solution of sodium polyphosphate (Calgone® N, sales product from Reckitt Benckiser GmbH) in deionized water, 2 g of a 20% strength by weight solution of sodium hydroxide in deionized water, 3 g of preservative (Parmetol® A 26, sales product from Schülke & Mayer GmbH),10 g of further preservative (Acticide® EPS, sales product from Thor Chemie), 96 g of a 2% strength by weight solution of a thickener (Walocel® MW 20000, sales product from Wolff Cellulosics GmbH & Co. KG) in deionized water, 12.5 g of a film-forming assistant (white spirit 180-210° C.), 7 g of a further film-forming assistant (Lusolvan® FBH, sales product from BASF AG), A g of titanium dioxide in the rutile modification (Kronos® 2190, Kronos Titan GmbH), B g of titanium dioxide in the anatase modification (Hombikat® UV 100, Sachtleben Chemie GmbH), 192 g of calcium carbonate (Omyacarb® 5 GU, Omya GmbH) and 48 g of talc (Finntalc® M15, Omya GmbH). After the end of the addition the pigment paste is stirred further for 20 minutes at 1000 revolutions per minute. Thereafter, with further stirring, 3 g of a defoamer (Agitan® 280, sales product from Münzing Chemie), 373 g of Acronal® S 790 and 11 g of deionized water were added to the paste. The aqueous coating material thus obtained was stirred for a further 20 minutes at 500 revolutions per minute. Prior to the further tests, the coating material was allowed to rest at room temperature for 24 hours. The following aqueous coating materials were prepared:

| | Coating material No. | | | |
|---|---|---|---|---|
| | C1 | C2 | C3 | C4 |
| Amount (A) of Kronos ® 2190 [g] | 173 | 164.4 | 155.7 | 138.4 |
| Amount (B) of Hombikat ® UV 100 [g] | 0 | 8.6 | 17.3 | 34.6 |
| PVC [%] | 43 | 43 | 43 | 43 |
| Solids content [% by weight] | 61.9 | 61.0 | 62.1 | 61.6 |

### Comparative Examples 5-8

At room temperature a pigment paste was prepared, with stirring using a disc stirrer at 1000 revolutions per minute, from (added in the order stated): 137 g of deionized water, 2 g of Pigmentverteiler A, 2 g of a 20% strength by weight solution of sodium hydroxide in deionized water, 3 g of a 25% strength by weight solution of Calgon® N in deionized water, 4 g of Parmetol® A 26, 50 g of a 2% strength by weight solution of a thickener (Natrosol® 250 HHR, sales product from Hercules Inc.) in deionized water, 4 g of a further thickener (Collacral® PU 85, sales product from BASF AG), 1 g of the defoamer Agitan® 280,12 g of white spirit 180-210° C., 12 g of a solvent (butyl diglycol), 12 g of a further solvent (propylene glycol), C g of Kronos® 2190, D g of Hombikat® UV 100, 175 g of Omyacarb® 5 GU and 55 g of Finntalc® M15. After the end of the addition the pigment paste was stirred further for 20 minutes at 1000 revolutions per minute. Thereafter, with further stirring, 2 g of Agitan® 280, 364 g of Acronal® DS 6254 and 6 g of deionized water were added to the paste. The aqueous coating material thus obtained was stirred for a further 20 minutes at 500 revolutions per minute. Prior to the further tests, the coating material was allowed to rest at room temperature for 24 hours. The following aqueous coating materials were prepared:

| | Coating material No. | | | |
|---|---|---|---|---|
| | C5 | C6 | C7 | C8 |
| Amount (C) of Kronos ® 2190 [g] | 155 | 147.2 | 139.5 | 124 |
| Amount (D) of Hombikat ® UV 100 [g] | 0 | 7.8 | 15.5 | 31 |
| PVC [%] | 43 | 43 | 43 | 43 |
| Solids content [% by weight] | 56.6 | 57.7 | 57.1 | 57.3 |

### Comparative Example 9 and Inventive Examples 10-12

At room temperature a pigment paste was prepared, with stirring using a disc stirrer at 1000 revolutions per minute, from (added in the order stated): 100 g of deionized water, 2 g of a preservative (Acticide® MBS, sales product from Thor Chemie GmbH), 2 g of a further preservative (Acticide® DW, sales product from Thor Chemie GmbH), 2.5 g of a thickener (Collacral® DS 6256, sales product from BASF AG), 0.5 g of a 25% strength by weight solution of ammonia in water, 8 g of a dispersant (AMP 90, sales product from Dow Chemicals), 10 g of a further dispersant (Pigmentverteiler MD 20, sales product from BASF AG), 10 g of a further dispersant (Collacral® LR 8954, sales product from BASF AG), 2 g of a defoamer (Tego LAE 511, sales product from Tego GmbH), E g of Kronos® 2190, F g of Hombikat® UV 100, 40 g of Omyacarb® 5 GU and 20 g Finntalc® M15. After the end of the addition the pigment paste was stirred further for 20 minutes at 1000 revolutions per minute. Thereafter, with further stirring, 632 g of the above-described aqueous composite-particle dispersion NK1, 1 g of a defoamer (Byk® 022, sales product from Byk-Chemie GmbH) and 20 g of a 5% strength by weight solution of a thickener (Collacral® LR 8990, sales product from BASF AG) in deionized water were added to the paste. The coating material thus obtained was stirred for a further 20 minutes at 500 revolutions per minute. Prior to the further tests, the coating material was allowed to rest at room temperature for 24 hours. The following aqueous coating materials were prepared:

| | Coating material No. | | | |
|---|---|---|---|---|
| | C9 | 10 | 11 | 12 |
| Amount (E) of Kronos ® 2190 [g] | 150 | 142.5 | 135 | 120 |
| Amount (F) of Hombikat ® UV 100 [g] | 0 | 7.5 | 15 | 30 |
| PVC [%] | 45.2 | 44.7 | 46.3 | 45.5 |
| Solids content [% by weight] | 43 | 43 | 43 | 43 |

III Performance Tests

The coating materials C1 to C9 and also 10 to 12 prepared under II were drawn down onto glass plates in a wet thickness of 400 μm and dried at 23° C. and 50% relative humidity for 1 week. Subsequently, the coated glass plates were subjected to accelerated weathering for 500 hours (Xenotest 1200 instrument, Heraeus, Hanau). The radiation output was in the wavelength range from 290 to 400 nm at 100±10 W/m². The relative atmospheric humidity in the sample chamber during the dry period was 60±5%. The sample chamber temperature was 37.5±2.5° C. The weathering cycles amounted to 3 minutes of irrigation and 17 minutes of drying, with the radiation source constantly in operation.

Before and after accelerated weathering the contact angles of the dried coating materials were measured. For this purpose, using a syringe with a blunt needle, three separate drops of water were applied to the surfaces of the coating materials on an optical bench, and a goniometer (in accordance with DIN EN 828) was used to determine the corresponding contact angles between water droplets and the surfaces of the coating materials. The lower the contact angle measured, the greater the evaluated hydrophilicity of a surface. In the examples the mean value of three individual measurements has been reported in each case.

Furthermore, before and after the accelerated weathering experiments, the Delta E—CIE Lab values (in accordance with DIN 53230) were measured for the purpose of assessing the yellowing of the different coating materials (Chromameter CR 200 instrument, Minolta). The b values were taken as a measure of the yellowing. It should be noted here that a higher Δb value reflects greater yellowing of the coating material.

As well as the yellowing, the chalking tendency of the coating materials as well was determined by the method of Kempf (in accordance with DIN 53159) following the accelerated weathering experiments. For this purpose, moistened black photographic paper was pressed using a die under a defined pressure of 250±25 N onto the surface of the dry coating materials and then removed again. After the photographic papers had dried, the chalking was assessed optically and evaluated according to a relative scale with a rating. The values 0 and 5 on this scale correspond to no chalking and extremely severe chalking, respectively. All other values are situated in between, in accordance with the school grade system.

The results obtained are summarized in the table below:

| | Yellowing after | Contact angle | Contact angle | Chalking after |
|---|---|---|---|---|
| Coating material | weathering | before weathering | after weathering | weathering |
| No. | [Δb] | [degrees] | [degrees] | [relative rating] |
| C1 | 1.08 | 77 | 25 | 3 |
| C2 | 1.32 | 81 | 17 | 4 |
| C3 | 1.59 | 82 | 13 | 4 |
| C4 | 1.91 | 87 | 14 | 5 |
| C5 | 0.79 | 94 | 69 | 0.5 |
| C6 | 1.03 | 95 | 24 | 3 |
| C7 | 1.24 | 92 | 17 | 3.5 |
| C8 | 1.6 | 96 | 15 | 4 |
| C9 | 0.61 | 66 | 51 | 0.5 |
| 10 | 0.35 | 67 | <10 | 1 |
| 11 | 0.22 | 69 | <10 | 1.5 |
| 12 | 0.26 | 68 | <10 | 2 |

From the results listed in the table it is clearly apparent that the inventive coating materials 10 to 12, in comparison to comparative examples C1 to C9, have a much lower yellowing and chalking tendency and also a substantially higher hydrophilicity.

1. An aqueous coating material comprising
a) particles having an average size ≧10 nm and ≦500 nm composed of an addition polymer and finely divided inorganic solid (composite particles) and
b) at least one pulverulent pigment selected from the group consisting of zinc oxide, zinc sulfide, iron(III) oxide, tin dioxide and titanium dioxide in the rutile, anatase and brookite modification.

2. The aqueous coating material according to claim 1, comprising as pulverulent pigment titanium dioxide in the anatase modification.

3. The aqueous coating material according to claim 2, comprising at least one further pulverulent pigment.

4. The aqueous coating material according to claim 1, comprising at least one pulverulent filler.

5. The aqueous coating material according to claim 1, wherein the polymer has a Tg value ≦150° C.

6. The aqueous coating material according to claim 1, wherein the composite particles have a finely divided inorganic solid content of ≧20% by weight.

7. The aqueous coating material according to claim 1, wherein the pigment volume concentration (PVC) is ≧10%.

8. The aqueous coating material according to claim 1, wherein the composite particles are in the form of an aqueous composite-particle dispersion.

9. The aqueous coating material according to claim 8, wherein the aqueous composite particle dispersion has been prepared by a process in which at least one ethylenically unsaturated monomer is dispersely distributed in an aqueous medium and is polymerized by means of at least one free-radical polymerization initiator in the presence of at least one dispersely distributed, finely divided inorganic solid and at least one dispersant by the method of free-radical aqueous emulsion polymerization, where
a) a stable aqueous dispersion of the at least one inorganic solid is used, said dispersion having the characteristic features that at an initial solids concentration of ≧1% by weight, based on the aqueous dispersion of the at least one inorganic solid, it still comprises in dispersed form one hour after its preparation more than 90% by weight of the originally dispersed solid, and its dispersed solid particles have a weight-average diameter ≦100 nm,
b) the dispersed particles of the at least one inorganic solid exhibit a nonzero electrophoretic mobility in an aqueous standard potassium chloride solution at a pH which corresponds to the pH of the aqueous dispersion medium before the addition of the dispersants is commenced,
c) at least one anionic, cationic and nonionic dispersant is added to the aqueous dispersion of solid particles before the addition of the at least one ethylenically unsaturated monomer is commenced,
d) thereafter, of the total amount of the at least one monomer, 0.01% to 30% by weight are added to the aqueous dispersion of solid particles and polymerization is carried out to a conversion of at least 90%
and
e) subsequently the remainder of the at least one monomer is added continuously under polymerization conditions in accordance with the rate of its consumption.

10. The aqueous coating material according to claim 1, wherein the finely divided inorganic solid is a silicon compound.

11. The aqueous coating material according to claim 1, wherein the finely divided inorganic solid comprises pyrogenic and/or colloidal silica, silicon dioxide sols and/or phyllosilicates.

12. The aqueous coating material according to claim 1, wherein the polymer comprises in copolymerized form 0.01% to 5% by weight of at least one ethylenically unsaturated monomer containing siloxane groups.

13. The aqueous coating material according to claim 1, comprising
5% to 85% by weight of composite particles,
0.05% to 20% by weight of pulverulent titanium dioxide in the anatase modification,
5% to 60% by weight of further pulverulent pigments,
0% to 80% by weight of pulverulent fillers, and
0% to 10% by weight of further customary auxiliaries,
based in each case on the solids content of the aqueous coating material.

14. A coated substrate comprising a substrate and a dried coating derived from an aqueous coating material according to claim 1.

15. A method of producing a coated substrate, which comprises applying to a substrate an aqueous coating material according to claim 1 and drying it under conditions in which the polymer forms a film.

16. The method according to claim 15, wherein the substrate is plastic, metal, wood, paper or a mineral.

17. A coated substrate obtainable by the method according to claim 15.

18. A coated substrate obtainable by the method according to claim 16.
